(19) United States
(12) Patent Application Publication
(10) Pub. No.: US 2006/0141926 A1
(43) Pub. Date: Jun. 29, 2006

(54) Call rejections and reminders in order to enhance enjoyment of media items

(75) Inventors: Akseli Anttilla, Helsinki (FI); Rob van der Haar, Helsinki (FI); Younghee Jung, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/027,468

(22) Filed: Dec. 29, 2004

(51) Int. Cl. H04H 7/00

(52) U.S. Cl. 455/3.06

(57) ABSTRACT

A mobile station rejects an incoming call. A call initiation signal associated with the incoming call is received from the second mobile station. It is determined whether the mobile station is in a given one of two or more predetermined communication states with a media player, wherein the given predetermined communication state defines that automatic communication of the rejection is to be performed. A rejection is communicated to a communication device associated with the incoming call in response to the mobile station being in the given predetermined communication state. A communication device reacts to a rejection from a mobile station. The rejection is received from the mobile station. A reminder comprising information is created about the mobile station. A time is associated with the reminder, where the associated time used to alert the communication device that the reminder should be presented. In response to elapse of the associated time, at least a portion of the information of the reminder is presented on one or more outputs accessible by the communication device.

### TECHNICAL FIELD

This invention relates generally to mobile telecommunication systems and, more specifically, relates to sending information between two parties using mobile stations.

### BACKGROUND OF THE INVENTION

Mobile stations have become important parts of the lives of many people around the world. Such mobile stations could be, for example, a cellular telephone, a personal digital assistant (PDA) having wireless capability, a personal communicator, or a messaging device having electronic mail, short messaging service (SMS), multimedia messaging service (MMS), or wireless capability such as local area network (LAN) capability.

Current and future mobile stations can be considered at least in part to be platforms for third party applications, and will support an increasing number of applications and accessories. In particular, media players (e.g., a multimedia application such as an image viewer, video player, or music player) using media items (e.g., images, games, video, audio, digital or analog television, or combinations of these) are becoming more popular. Typically, a user will use his or her mobile station to access a media item through a media player. The media player and the media items will usually be located on the mobile station for the user, but the media player and media items may be remotely located and accessed through a wireless network, such as a cellular network, a LAN, a wide-area network (WAN), or a personal area network (PAN) using Bluetooth or other technology. Additionally, the media player (e.g., or a portion thereof) could be located on the mobile station, but the media items could be remotely located and accessed through a wireless network. Furthermore, wired networks, such as plain old telephone system (POTS) network or wired LANs or WANs may be used in addition to or in replacement of the wireless network.

When a user is engaged in enjoying one or more media items using a mobile station with network communication capabilities, he or she can at any time be interrupted by incoming calls. Typically, such calls require attention of the user, and more often than not, the attention should be rather immediate. These interruptions can decrease the enjoyment by the user of the media items, particularly for the media items that require immersion or are ephemeral. It would therefore be desirable to provide techniques that enhance enjoyment by the user of media items accessed using mobile stations while still allowing user to be socially appropriate.

### BRIEF SUMMARY OF THE INVENTION

The foregoing and other problems are overcome, and other advantages are realized, in accordance with the presently preferred embodiments of these teachings. In particular, the present invention provides techniques that can enhance enjoyment by the user of media items accessed using mobile phones.

In an exemplary aspect of the invention, techniques are performed on a mobile station for rejecting an incoming call. A call initiation signal associated with the incoming call is received from the second mobile station. It is determined whether the first mobile station is in a given one of two or more predetermined communication states with a media player. The given predetermined communication state defines that automatic communication of the rejection is to be performed. A rejection is communicated to a communication device associated with the incoming call in response to the first mobile station being in the given predetermined communication state.

In another exemplary aspect of the invention, techniques are performed on a communication device for reacting to a rejection from a mobile station. For instance, the rejection is received from the mobile station. A reminder is created about the mobile station, where the reminder comprises information. A time is associated with the reminder, and the associated time is used to alert the communication device that the reminder should be presented. In response to elapse of the associated time, at least a portion of the information of the reminder is presented on one or more outputs accessible by the communication device.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a simplified block diagram of an exemplary wireless telecommunication network operating in accordance with an exemplary embodiment of the present invention;

FIG. 2 is an exemplary signaling diagram for a rejection of a caller mobile station;

FIG. 3 is an exemplary signaling diagram for a rejection, of a caller mobile station, having associated simple media information;

FIG. 4 is an exemplary signaling diagram for a rejection, of a caller mobile station, having associated complex media information; and

FIG. 5 is an exemplary signaling diagram, of a caller mobile station, for alerts for a recipient mobile station and reminders for a caller mobile station.

### DETAILED DESCRIPTION OF EXEMPLARY EMBODIMENTS

As previously described, when a user is engaged in enjoying one or more media items using a mobile station, he or she can at any time be interrupted by incoming calls. These interruptions can decrease the enjoyment by the user of the media items, especially if the media item content requires immersion of the user or is ephemeral. Several methods of managing the intrusiveness of incoming calls exist, but these existing methods are not related to, or suitable for usage of media items by a recipient or his or her mobile station. For example, current techniques include using the mobile station's profiles to define a list of callers whose incoming calls will be alerted to the recipient and using Presence-enhanced Contacts to set the availability information of the recipient to a caller, via a service provided with the Wireless Village standard.

By contrast, exemplary embodiments of the present invention allow incoming calls to be rejected when the recipient is in the process of enjoying one or more media items using a recipient mobile station. Hereby, “incoming calls” mean incoming requests for communication by other users who have access to a communication network to which the mobile station is connected. Such requests could include, for instance, chat requests, incoming voice calls, messages such as short messaging service (SMS) messages and multimedia messaging service (MMS messages), and game interactions such as game challenges. The rejection is typically a “soft rejection,” meaning the caller is given an indication that the user is engaged in a task and does not wish to answer an incoming call. In certain exemplary embodiments, information about the enjoyed media item may be used to give more specific feedback to the caller about the availability of the recipient. For example, the caller could be informed that the recipient is enjoying a media item and does not wish to be disturbed. As another example, the caller could be further informed of a time when the recipient should become available (e.g., when the recipient should be done enjoying the media item). In another exemplary embodiment, the caller can also be offered the opportunity to join the recipient in enjoying the same media item. In yet another embodiment, the caller mobile station can use a reminder to inform the caller that the recipient has likely completed enjoying the media item and can likely accept a call.

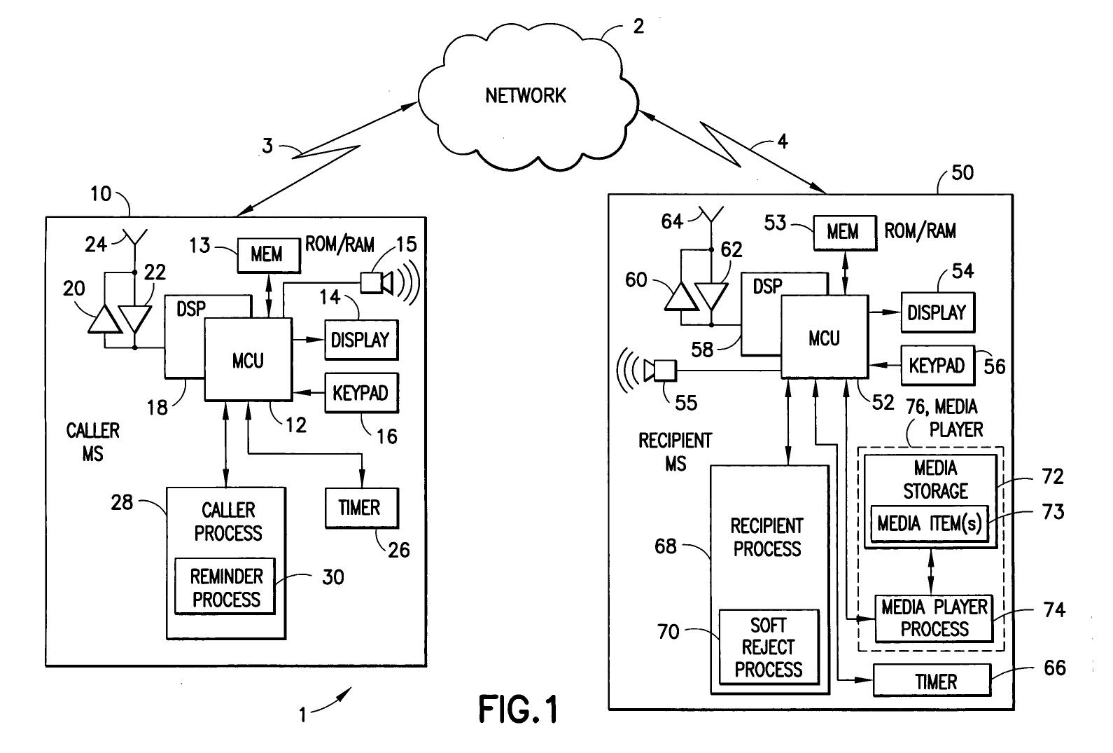

Turning now to FIG. 1, there is illustrated a simplified block diagram of an embodiment of an exemplary wireless telecommunications system 1 that includes a plurality of mobile stations, of which a caller mobile station 10 and a recipient mobile station 50 are shown. FIG. 1 also shows an exemplary network 2 communicating with the caller mobile station 10 and the recipient mobile station 50 through wireless communication paths 3 and 4, respectively. As is known in the art, the network 2 may have, for example, the following devices (not shown): a mobile switching center (MSC) for connecting to a telecommunications network, such as the public switched telephone network (PSTN); one or more base station controllers (BSCs); and a plurality of base transceiver stations (BTSs) that transmit in a forward (e.g., downlink) communication path both physical and logical channels to the mobile stations 10 and 50 in accordance with a predetermined air interface standard. It is assumed that a reverse (e.g., uplink) communication path exists from the mobile stations 10 and 50 to the network 2, which conveys mobile-originated access requests and traffic, as well as signaling for implementing the teachings of this invention. For simplicity, wireless communication paths 3 and 4 each represent a forward and reverse communication path.

In an exemplary embodiment of these teachings, the air interface standard conforms to a time division multiple access (TDMA) air interface, and the network may be a GSM network. However, the teachings of this invention apply equally to code division multiple access (CDMA) networks, as well as to other network types.

The network 2 can include a message service center (MSCT), not shown, that receives and forwards messages for the mobile stations 10 and 50, such as short message service (SMS) messages, or any wireless messaging technique including e-mail and supplementary data services (SDS). Furthermore, enhancements to SMS can be used, such as the multimedia messaging service (MMS), wherein image messages, video messages, audio messages, text messages, executables and the like, and combinations thereof, can be transferred between a network 2 and a mobile station 10 or 50.

The caller mobile station 10 typically includes a microcontrol unit (MCU) 12 having an output coupled to an input of a display 14 and an input coupled to an output of a keyboard or keypad 16. The caller mobile station 10 may be considered to be a handheld radiotelephone, such as a cellular telephone, a personal digital assistant (PDA) having wireless capability, a personal communicator, or a messaging device, and may have a microphone (not shown) and a speaker 15 for conducting voice communications and for playing information for reminders (described below). In this example, the speaker 15 and display 14 are outputs of the caller mobile station 10, and the outputs could be separate from but coupled to the caller mobile station 10. The caller mobile station 10 also comprises a caller process 28 and a timer 26. The caller process 28 comprises a reminder process 30.

The caller mobile station 10 also contains a wireless section that includes a digital signal processor (DSP) 18, or equivalent high speed processor, as well as a wireless transceiver comprised of a transmitter 20 and a receiver 22, both of which are coupled to an antenna 24 for communication with the network 2.

Timer 26 is shown separately from MCU 12 and DSP 18. However, the timer 26 may be included in one or both of the MCU 12 and DSP 18. Additionally, the MCU 12 and DSP 18 may be implemented as a single processor or may be further subdivided into additional processors.

The MCU 12 is assumed to include or be coupled to some type of a memory 13, including a read-only memory (ROM) for, e.g., storing an operating program, as well as a random access memory (RAM) for, e.g., temporarily storing required data, scratchpad memory, received data packets and data packets prepared for transmission. A separate, removable subscriber identity module (SIM), not shown, can be provided as well, the SIM storing, for example, a preferred public land mobile network (PLMN) list and other subscriber-related information. The memory 13 may also contain a hard drive or other suitable long-term storage. The memory 13 is assumed, for the purposes of this invention, to store a program enabling the MCU 12 to execute the software routines required to operate in accordance with the exemplary embodiments of these teachings. It should be noted that the caller mobile station 10 need not be a wireless device and, instead, may be a communication device, such as a telephone that communicates over the POTS to the network 2 or a PDA that communicates using voice over internet protocol (VoIP) to the network 2.

The recipient mobile station 50 typically includes an MCU 52 having an output coupled to an input of a display 54 and an input coupled to an output of a keyboard or keypad 56. The recipient mobile station 50 may be considered to be a handheld radiotelephone, and will also generally include a speaker 55 and microphone (not shown). The speaker 55 and the display 54 are exemplary outputs of the recipient mobile station 50, and the outputs could be separate from but coupled to the recipient mobile station 50 The recipient mobile station 50 also comprises a recipient process 58, a timer 66, and a media player 76. Media player 76 comprises a media player process 74 and media storage 72 that comprises one or more media items 73. It should be noted that the media items 73 can be stored independently of the media storage 72, if desired. The recipient process 58 comprises a soft reject process 70.

The recipient mobile station 50 also contains a wireless section that includes a digital signal processor (DSP) 58, or equivalent high speed processor, as well as a wireless transceiver comprised of a transmitter 60 and a receiver 62, both of which are coupled to an antenna 64 for communication with the network 2. Timer 66 is shown separately from MCU 52 and DSP 58. However, the timer 66 may be included in one or both of the MCU 52 and DSP 58. Additionally, the MCU 52 and DSP 58 may be implemented as a single processor or may be further subdivided into additional processors.

The MCU 52 is assumed to include or be coupled to some type of a memory 53, including a ROM as well as a RAM. A separate, removable SIM (not shown) can be provided as well. The memory 53 is assumed, for the purposes of this invention, to store a program enabling the MCU 52 to execute the software routines required to operate in accordance with the exemplary embodiments of these teachings.

One or both of the mobile stations 10 and 50 could also be contained within a card or module that is connected during use to another device. For example, the recipient mobile station 50 could be contained within a personal computer memory card international association (PCMCIA) or similar type of card or module that is installed during use within a portable data processor, such as a laptop or notebook computer, or even a computer that is wearable by the user.

As is known in the art, the caller process 28, recipient process 68, media storage 72, and media player process 74 will be loaded as necessary into memories 13 or 53 and into DSPs 18 or 58 and MCUs 12 and 52 for execution or processing.

For the purposes of exposition, the rest of the present disclosure assumes that the media player 76 (e.g., or a portion thereof) is located in the mobile station 50 and has a media player process 74 that provides an interface to the media items 73 in the media storage 72. Nonetheless, the media player 76 could be remote from the recipient mobile station 50. For instance, the media player 76 could reside in network 2 or on a wired or wireless LAN or WAN to which the recipient mobile station 50 has access. Additionally, the media storage 72 may reside of the recipient mobile station 50 and the media player 76 may reside on the recipient mobile station 50. The media storage 72 may reside in the recipient mobile station 50 but be separate from, but accessible by, the media player 76. In the latter example, the media player 76 and media player process 74 could be combined into a single device, such as a multimedia application. A media player 76 is any application or device or both able to play media items such as images, games, video, audio, digital or analog television, or combinations of these.

The caller process 28 and recipient process 68 control the functions performed by the caller mobile station 10 and recipient mobile station 50, respectively. For instance, the caller process 28 can place a call to the recipient mobile station 50. The network 2 operates to physically communicate the call to the recipient mobile station 50. As described in more detail below, the soft reject process 70 can determine if a recipient is using media item 73 through, for instance, communication with the media player 76 of the media item 73 and will communicate a rejection to the caller mobile station 10 in response to determining that the recipient is using a media item 73.

One exemplary technique for determining if a recipient is using a media item 73 is to determine whether the mobile station 50 is in a predetermined communication state with the media player 76. As an example, a predetermined communication state could indicate a current communication with the media player (e.g., transfer of a portion of a media item 73 from the media player 76 to some portion of the recipient mobile station 50; a command communicated between the recipient mobile station 50 and the media player 76). A second example is a predetermined communication state that indicates a communication, with the media player, which is expected to start within a predetermined time. The predetermined time is typically determined from when a determination of the communication state is performed. Yet another possible communication state indicates a communication, with the media player, where the communication is paused. Thus, the communication state could indicate if a recipient pauses the communication and therefore playback of a media item 73. Optionally, no rejection could be sent and an incoming call will be accepted when the recipient pauses a communication with the media player 76.

As another example, it can be determined that the recipient mobile station 50 is in a certain predetermined communication state with the media player 76 by the setting of a “media soft reject” state (not shown) for the recipient mobile station 50. The setting of the “media soft reject” state may be performed by the soft reject process 70 when the soft reject process 70 determines any communication with the media player 76 has been performed or, more typically, when the media player process 74 is started. Additionally, the media player process 74 can set the “media soft reject” state when the media player process 74 is started.

The soft reject process 70 can communicate a rejection to the caller mobile station 10. Such a rejection is typically a soft rejection, which indicates (as described in more detail below) that the recipient is unavailable. The rejection may also be a rejection such as a busy signal or a transfer to voice mail, e.g., without additional information explaining the reason for rejection. The rejection can be simple (e.g., “the recipient cannot answer now”) or complex (e.g., “the recipient is watching a program and will be done watching in about one hour”).

The reminder process 30 is a process that can receive a rejection and create one or more reminders. The reminder process 30 also generally associates a time with the reminders. Such time can be set by, for instance, metadata information of the media item the recipient media player is currently handling, by considering the remaining playback length of the movie as reported by the metadata. In response to the elapse of the predetermined time, the reminder process will display (e.g., using display 14) a portion or the entire reminder to the caller. The reminder can comprise information, including text, audio, images, or video.

As described in additional detail below, the soft reject process 70 can set alerts to alert the recipient that the caller called, where the alerts possibly include information about the context of rejection and soft rejection information provided to the caller. The soft reject process may also include, as part of the rejection, an invitation to participate in the media item 73.

The caller process 28, recipient process 68 and the media player process 74 may be comprised of multiple sub-processes. Additionally, the reminder process 30 could be separate from the caller process 28. Similarly, the soft reject process 70 may be separate from the recipient process 68. Furthermore, as is known in the art, the memories 13 and 53 may comprise computer program product that is stored on a computer readable medium and that comprises program instructions to perform steps of embodiments of the present invention.

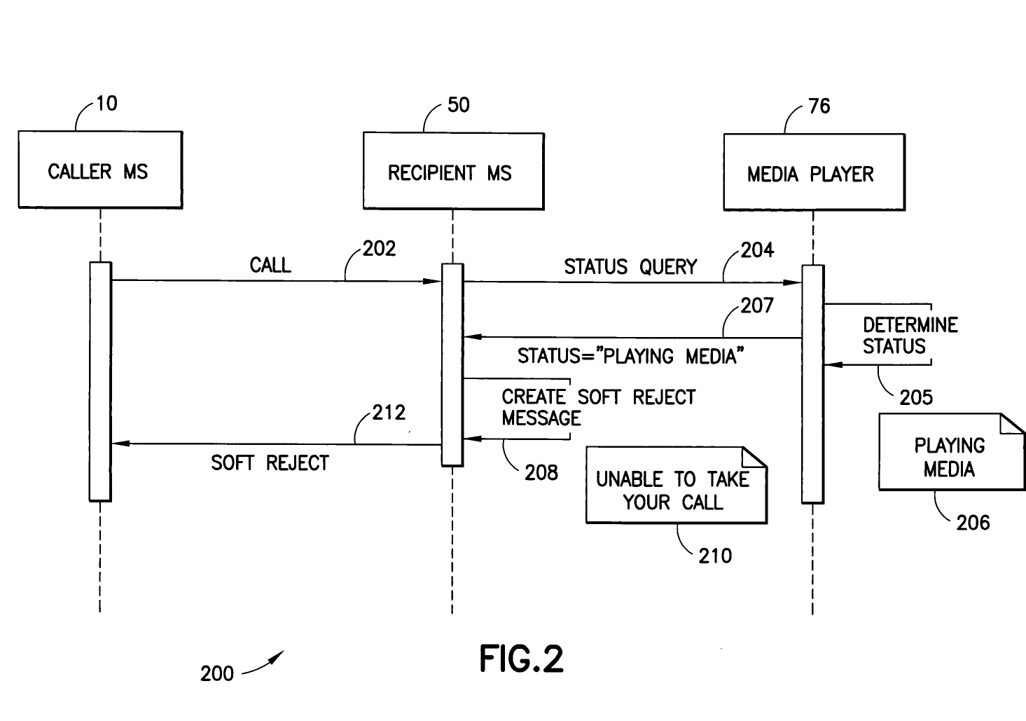

FIGS. 2 through 5 show exemplary signaling diagrams between a caller mobile station 10, a recipient mobile station 50, and a media player 76 in order for the recipient mobile station 50 to reject a call from the caller mobile station 10, in order for reminders to be created on the caller mobile station 10 and in order for alerts to be created on the recipient mobile station 50.

Turning now to FIG. 2, an exemplary signaling diagram 200 for a simple rejection of a caller mobile station 10 is shown. Signaling diagram 200 shows various signaling that occurs between a caller mobile station 10, a recipient mobile station 50, and a media player 76.

In FIG. 2, a caller, using the caller mobile station 10, attempts to contact a recipient, using recipient mobile station 50. The caller mobile station 10 (e.g., the caller process 28 of caller mobile station 10) communicates a call initiation signal 202 to the recipient mobile station 50. The call initiation signal 202 is a request for communication. As described previously, such requests could include, for instance, chat requests, incoming voice calls, messages such as short messaging service (SMS) messages and multimedia messaging service (MMS messages), and game interactions such as game challenges. The recipient mobile station 50 (e.g., the soft rejection process 70 of the recipient process 68 of the recipient mobile station 50) communicates a status query signal 204 to the media player 76. The status query signal 204 is an exemplary technique for determining whether the recipient mobile station 50 is in one of a number of predetermined communication states with the media player 76.

The media player 76 (e.g., the media player process 74 of the media player 76) determines status of communication by performing, as an example, a “determine status” method 205. The “determine status” method 205 will return the status 206 of “Playing media” to the recipient mobile station 50 through the status signal 207. The status 206 indicates a status of a communication of a media item 73 between a portion of the recipient mobile station 50 (e.g., the display 54, DSP 58, or MCU 52) and the media player 76. The status 206 can be interpreted to determine whether the recipient mobile station 50 is in a given communication state with the media player 76. In this example, “Playing media” may be interpreted as a communication state of “currently communicating,” for example. The status 206 could also be, e.g., “Will start media within X time,” “Currently paused,” or “Not playing media.” These can be interpreted, illustratively, as being communication states of “starting soon,” “paused,” and “not communicating,” respectively. Additionally, the status 206 could be “Not in media soft reject state” (e.g., interpreted as a communication state of “not communicating”) or “In media soft reject state” (e.g., interpreted as a state of “currently communicating”).

As an additional example, the recipient mobile station 50 could, in response to receiving the “Playing media” status, then set the recipient mobile station 50 in the “media soft reject” state. If the recipient mobile station 50 receives a “Not playing media” status 206 in the status signal 206, the recipient mobile station 50 could set the recipient mobile station 50 in a “not in a media soft reject” state, which could be interpreted as a “not communicating” communication state. The “media soft reject” state can correspond to a “started” status of the media player 76, thereby indicating that the media player 76 has been started. Similarly, the “not in a soft reject” state can correspond to a “not started” status of the media player 76, thereby indicating that the media player has not been started. Furthermore, the recipient mobile station 50 could determine that the media player 76 has been started and set the “media soft reject” state, or the media player 76 itself could set the “media soft reject” state on the recipient mobile station 50 when the media player 76 starts (e.g., and set a “not in a media soft reject” state when the media player 76 stops).

In one exemplary embodiment, the communication states of “starting soon,” “paused,” and “currently communicating” cause a rejection (e.g., soft reject signal 212, described in more detail below) to be communicated to the caller mobile station 10, while the communication state of “not communicating” does not cause a rejection to be communicated to the caller mobile station 10. In another exemplary embodiment, the communication states of “starting soon” and “currently communicating” cause a rejection to be communicated to the caller mobile station 10, while the communication states of“paused” and “not communicating” do not cause a rejection to be communicated to the caller mobile station 10. In yet another exemplary embodiment, the communication states of “currently communicating” causes a rejection to be communicated to the caller mobile station 10, while the communication states of “starting soon,” “paused” and “not communicating” do not cause a rejection to be communicated to the caller mobile station 10. In a still further exemplary embodiment, there are two communication states of “currently communicating” or “not communicating,” corresponding to a “media soft reject” state for the recipient mobile station 50 or a “not in a media soft reject” state for the recipient mobile station 50, respectively. The communication state of “currently communicating” causes a rejection to be communicated to the caller mobile station 10, while the communication state of “not communicating” does not cause a rejection to be communicated to the caller mobile station 10. It should also be noted that the communication state itself may be the “media soft reject” state or the “not in a media soft reject” state.

The recipient mobile station 50 (e.g., the soft reject process 70) performs a “create soft reject message” method 208, where the soft reject message 210 includes the text information, “Unable to take your call.” The recipient mobile station 50 (e.g., the soft reject process 70 or the recipient process 68) then communicates the soft reject message 210 to the caller mobile station 10 as part of the soft reject signal 212, which is one type of rejection. The soft reject message 210 (e.g., or the soft reject signal 212) can also contain information suitable for diverting the caller to, e.g., voice mail or message creation at the caller mobile station 10. Similarly, the soft reject message 210 (e.g., or the soft reject signal 212) can also contain information such as text, audio, images, or video.

It should be noted that in an embodiment where the media player 76 (e.g., or a portion thereof) is part of the recipient mobile station 50, the signals 204 and 207 would occur internally to the recipient mobile station 50. Furthermore, a call associated with the call initiation request signal 202 can be a typical cellular telephone call or could be a message such as a SMS or MMS or could be for both a typical cellular telephone call and a message.

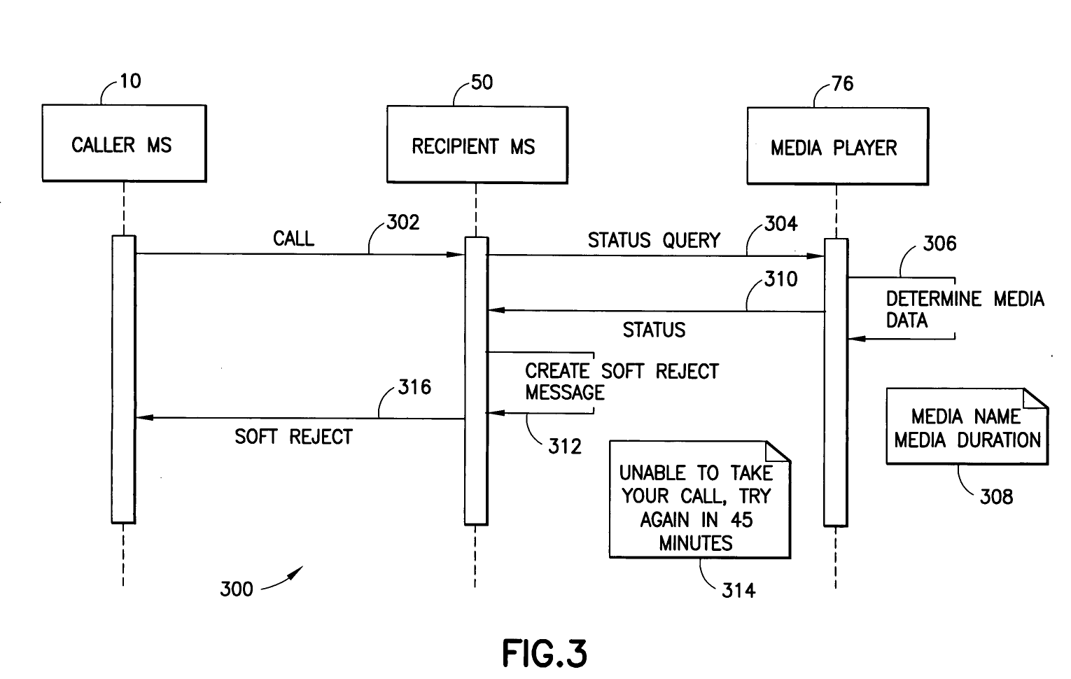

Referring now to FIG. 3, an exemplary signaling diagram 300 is shown for a rejection, of a caller mobile station, having associated simple media information. In this example, the caller, using the caller mobile station 10, attempts to contact a recipient, using recipient mobile station 50. The caller mobile station 10 (e.g., the caller process 28 of caller mobile station 10) communicates a call initiation signal 302 to the recipient mobile station 50. The recipient mobile station 50 (e.g., the soft rejection process 70 of the recipient mobile station 50) communicates a status query signal 304 to the media player 76. The status query signal 304 is an exemplary technique for determining whether the recipient mobile station 50 is in one of a number of predetermined communication states with the media player 76. The media player 76 (e.g., the media player process 74 of the media player 76) determines status of communication by performing, as an example, a “determine media data” method 206. The “determine media data” method 206 returns the media data 308 of “media name, media duration” to the recipient mobile station 50 through the status signal 310. It should be noted that if the “determine media data” method 206 does not return any media information in media data 308, then it can be assumed that the recipient mobile station 50 is not in one of the number of predetermined communication states with the media player 76.

The recipient mobile station 50 (e.g., the soft reject process 70) performs a “create soft reject message” method 312, where the soft reject message 314 includes the text, “Unable to take your call, try again in 45 minutes.” The “create soft reject message” method 312 uses the media information in media data 308 to determine the soft reject message 314. The recipient mobile station 50 (e.g., the soft reject process 70 or the recipient process 68) then communicates the soft reject message 314 to the caller mobile station 10 as part of the soft reject signal 314, which is one type of rejection.

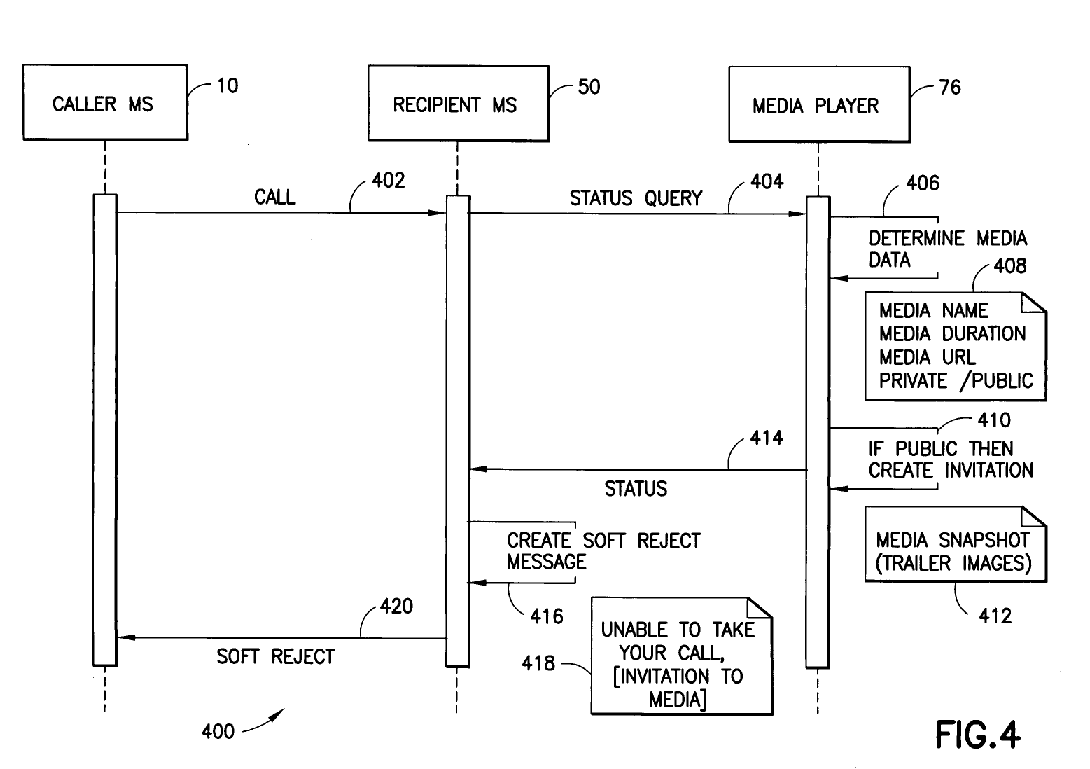

Turning now to FIG. 4, an exemplary signaling diagram 400 is shown for a rejection, of a caller mobile station, having associated complex media information. As with FIGS. 2 and 3, the caller, using the caller mobile station 10, attempts to contact a recipient, using recipient mobile station 50. The caller mobile station 10 (e.g., the caller process 28 of caller mobile station 10) communicates a call initiation signal 402 to the recipient mobile station 50. The recipient mobile station 50 (e.g., the soft rejection process 70 of the recipient mobile station 50) communicates a status query signal 404 to the media player 76. The status query signal 404 is an exemplary technique for determining whether the recipient mobile station 50 is in one of a number of predetermined communication states with the media player 76.

The media player 76 (e.g., the media player process 74 of the media player 76) determines status of communication by performing, as an example, a “determine media data” method 406. The “determine media data” method 406 determines the media data 408 of “media name, media duration, media URL, private|public,” where the URL is a uniform resource locator and the “private|public” indicates whether the media name (e.g., and media duration) of a media item 73 is to be held private or is public. It should be noted that if the “determine media data” method 406 does not return any media information in media data 408, then it can be assumed that the recipient mobile station 50 is in not in one of the number of predetermined communication states with the media player 76.

The recipient mobile station 50 (e.g., the soft reject process 70) performs an “if public then create invitation” method 410. Method 410 creates invitation 412, which includes a media snapshot (e.g., trailer images) to be used in a soft reject message 418 when the media name of the media item 73 is public. The media data 408 and invitation 412 are communicated by the media player 76 (e.g., by the media player process 74) to the recipient mobile station 50 through the status signal 414.

The recipient mobile station 50 (e.g., the soft reject process 70) performs a “create soft reject message” method 416, where the soft reject message 418 includes the text, “Unable to take your call.” The soft reject message 418 further includes an “invitation to media” (e.g., including invitation 412) for the caller to join (e.g., view, hear, download, play, or participate in playing, or some combination thereof) the media item 73. The “create soft reject message” method 420 uses the media information in media data 408 and the invitation 412 to determine the soft reject message 420. The “invitation to media” in the soft reject message 418 can include an invitation to the media item (e.g., “see URL to join me”). The invitation 412 can be, for instance, to a media messaging application, where users can message while enjoying the media item, such as that described in US patent application 2003/0126211, “Synchronous Media Playback and Messaging System,” by inventors Anttila and Jung, filed on Dec. 12, 2001, the disclosure of which is hereby incorporated by reference.

The recipient mobile station 50 (e.g., the soft reject process 70 or the recipient process 68) then communicates the soft reject message 420 to the caller mobile station 10 as part of the soft reject signal 420, which is one type of rejection.

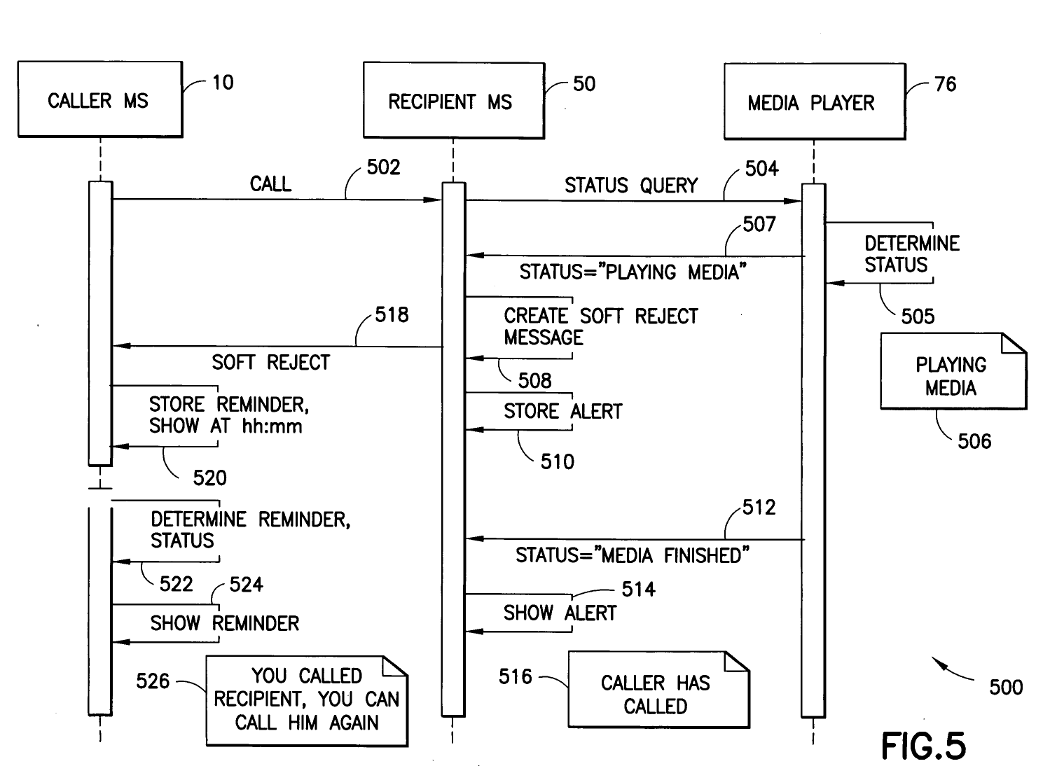

Referring to FIG. 5, an exemplary signaling diagram 500, of a caller mobile station, is shown for alerts for a recipient mobile station 50 and reminders for a caller mobile station 10. As with FIGS. 2-4, the caller, using the caller mobile station 10, attempts to contact a recipient, using recipient mobile station 50. The caller mobile station 10 (e.g., the caller process 28 of caller mobile station 10) communicates a call initiation signal 502 to the recipient mobile station 50. The recipient mobile station 50 (e.g., the soft rejection process 70 of the recipient mobile station 50) communicates a status query signal 504 to the media player 76. The status query signal 504 is an exemplary technique for determining whether the recipient mobile station 50 is in one of a number of predetermined communication states with the media player 76.

The media player 76 (e.g., the media player process 74 of the media player 76) determines status of communication by performing, as an example, a “determine status” method 505. The “determine status” method 505 will return the status 206 of “Playing media” to the recipient mobile station 50 through the status signal 507.

The recipient mobile station 50 (e.g., the soft reject process 70) performs a “create soft reject message” method 508. A soft reject message is not shown in FIG. 5. The recipient mobile station 50 (e.g., the soft reject process 70) performs a “store alert” method 510 that creates and stores an alert 516. The media player 76 (e.g., the media player process 74) communicates the status signal 512 including a “Media finished” indication to the recipient mobile station 50. In response to the status signal 512, the recipient mobile station 50 (e.g., the soft reject process 70) performs a “show alert” method 514 that then displays (e.g., on display 54) to the recipient the alert 516 having the text “Caller has called.” Also, the timer 66 may be used to set a time period after the reception of the status signal 512 for the recipient mobile station 50 to show the alert 516. The alert 516 can comprise any of text, audio and video information suitable for presentation to a user.

The recipient mobile station 50 communicates the soft reject signal 518, a type of rejection, to the caller mobile station 10. In response to the soft reject signal 518, the caller performs a “store reminder” method 520 that creates and stores a reminder 526. Additionally, the “store reminder” method 520 also can associate a time with the reminder. In this case, the “show at hh:mm” of FIG. 5 is associated with the reminder and the timer 26 is set to trigger performance of the “determine reminder status” method 522 and therefore alert the caller mobile station 10 to the reminder. If the “determine reminder status” method 522 determines that the reminder should be shown, the caller mobile station 10 (e.g., the reminder process 30) performs the “show reminder” method 524 and the reminder 526 (or a portion thereof) of “You called recipient, you can call him again” is shown on display 14. The reminder 526 can comprise any of text, audio, images, and video information suitable for presentation to a user. The reminder 526 (e.g., or a portion thereof) is typically presented to the user in response to elapsing of the time period hh:mm (e.g., 30 minutes) or elapsing of the specific time hh:mm (e.g., 2:30 p.m.). Elapsed means that the time hh:mm has been reached or occurs in the past.

In this example, the “store reminder” method 520 sets a fixed time (e.g., a time period relative to a current time or a specific time such as 15:00). If the method 505 includes additional information about the media item 73 being enjoyed, such as the media duration (see FIG. 3), the soft reject message 518 may contain an estimated duration to complete (see soft reject message 314 of FIG. 3), such as “try again in 45 minutes,” and/or contain a time when the media item 73 should be completed, such as “should be completed at 15:00.” The media duration and a current time may be used to estimate the time associated with the reminder, where the estimated time should occur after the recipient is done enjoying the media item 73. Alternatively, the time 15:00 could be used as the time associated with the reminder. Any other techniques suitable for determining a time associated with a reminder may be used.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the present invention, and not in limitation thereof.

What is claimed is:

1. A method performed on a mobile station for rejecting an incoming call, comprising:
receiving a call initiation signal associated with the incoming call;
determining whether the mobile station is in a given one of two or more predetermined communication states with a media player, wherein the given predetermined communication state defines that automatic communication of the rejection is to be performed; and
communicating a rejection to a communication device associated with the incoming call in response to the mobile station being in the given predetermined communication state.

2. The method of claim 1, wherein the call comprises a cellular telephone call or one or more messages or both.

3. The method of claim 1, wherein the two or more predetermined communication states correspond to and indicate at least the following:
a current communication exists between the mobile station and the media player; and
no current communication exists between the mobile station and the media player.

4. The method of claim 3, wherein the two or more predetermined communication states further correspond to and indicate at least the following:
a future communication between the mobile station and the media player, the future communication expected to start within a predetermined time from the step of determining.

5. The method of claim 3, wherein the two or more predetermined communication states further correspond to and indicate at least the following:
the current communication between the mobile station and the media player, where the current communication is paused.

6. The method of claim 1, wherein the two or more predetermined communication states comprise a “communicating” state and a “not communicating” state, and wherein the given state is the “communicating” state.

7. The method of claim 1, wherein the two or more predetermined communication states correspond to a status of a communication of a media item from the media player to the mobile station.

8. The method of claim 1, wherein the two or more predetermined communication states correspond to a status of the media player.

9. The method of claim 8, wherein the status of the media player is “not started” or “started.”

10. The method of claim 1, wherein the rejection comprises a soft reject signal, the soft reject signal comprising information.

11. The method of claim 10, wherein the information comprises one or more of text, audio, one or more images, and video.

12. The method of claim 10, wherein the information is suitable for diverting a caller using the communication device to one or more of voice mail and message creation.

13. The method of claim 10, wherein the information comprises one or more of media name and media duration.

14. The method of claim 10, wherein the information comprises an invitation to join a media item.

15. The method of claim 14, wherein the invitation comprises one or more of a media snapshot and a uniform resource locator (URL).

16. The method of claim 1, wherein at least a portion of the media player is located on the mobile station or no portion of the media player is located on the mobile station.

17. The method of claim 1, further comprising the step of creating an alert in response to the step of communicating a rejection, the alert comprising information.

18. The method of claim 17, wherein:
the two or more predetermined communication states correspond to a media item;
the alert corresponds to the media item; and
the method further comprises the step of presenting, in response to an indicated completion of the media item, at least a portion of the information of the alert on one or more outputs of the mobile station.

19. A mobile station that rejects an incoming call, the mobile station comprising:
one or more memories; and
one or more processors coupled to the one or more memories, the one or more processors configured to perform the steps of:
receiving a call initiation signal associated with the incoming call;
determining whether the mobile station is in a given one of two or more predetermined communication states with a media player, wherein the given predetermined communication state defines that automatic communication of the rejection is to be performed; and
communicating a rejection to a communication device associated with the incoming call in response to the mobile station being in the given predetermined communication state.

20. A computer program product that is stored on a computer readable medium and that comprises program instructions to perform the steps of:
receiving a call initiation signal associated with the incoming call;
determining whether a mobile station is in a given one of two or more predetermined communication states with a media player, wherein the given predetermined communication state defines that automatic communication of the rejection is to be performed; and
communicating a rejection to a communication device associated with the incoming call in response to the mobile station being in the given predetermined communication state.

21. A method performed on a communication device for reacting to a rejection from a mobile station, comprising:
receiving the rejection from the mobile station;
creating a reminder about the mobile station, the reminder comprising information;
associating a time with the reminder, the associated time used to alert the communication device that the reminder should be presented; and
presenting, in response to elapse of the associated time, at least a portion of the information of the reminder on one or more outputs accessible by the communication device.

22. The method of claim 21, wherein the step of creating further comprises the step of creating a reminder to call a recipient associated with the mobile station.

23. The method of claim 21, wherein the step of creating further comprises the step of creating a reminder that a multimedia item associated with the mobile station may be finished.

24. The method of claim 21, wherein the step of associating a time for the reminder further comprises the step of determining the associated time by using one or more additional times in the rejection.

25. The method of claim 24, wherein the step of determining the associated time by using one or more additional times in the rejection further comprises the step of setting the associated time as a given one of the one or more additional times.

26. The method of claim 24, wherein the step of determining the associated time by using one or more additional times in the rejection further comprises the steps of:
determining a current time; and
setting the associated time as the current time added to a value corresponding to given one of the one or more additional times.

27. The method of claim 21, wherein the information comprises one or more of text, audio, one or more images, and video.

28. A communication device that reacts to a rejection from a mobile station, the communication device comprising:
one or more memories; and
one or more processors coupled to the one or more memories, the one or more processors configured to perform the steps of:
receiving the rejection from the mobile station;
creating a reminder about the mobile station, the reminder comprising information;
associating a time with the reminder, the associated time used to alert the communication device that the reminder should be presented; and
presenting, in response to elapse of the associated time, at least a portion of the information of the reminder on one or more outputs coupled to the communication device.

29. A computer program product that is stored on a computer readable medium and that comprises program instructions to perform the steps of:
receiving a rejection from a mobile station;
creating a reminder about the mobile station, the reminder comprising information;
associating a first time with the reminder, the associated time used to alert the communication device that the reminder should be presented; and
presenting, in response to elapse of the associated time, at least a portion of the information of the reminder on one or more outputs accessible by a communication device.
